(19) United States
(12) Patent Application Publication
(10) Pub. No.: US 2025/0100805 A1
(43) Pub. Date: Mar. 27, 2025

(54) CONTAINER TRANSPORT WITH REDUCED WEAR

(71) Applicant: KRONES AG, Neutraubling (DE)

(72) Inventors: Hendrik GADOMSKI, Obertraubling (DE); Torsten KILGENSTEIN, Geisenfeld (DE); Ines BRADSHAW, Regensburg (DE); Lydia TIEDEMANN, Dresden (DE)

(21) Appl. No.: 18/293,578

(22) PCT Filed: Jul. 28, 2022
(86) PCT No.: PCT/EP2022/071201

§ 371 Date: Jan. 30, 2024

(30) Foreign Application Priority Data
Aug. 9, 2021 (DE) 102021120653.7

(51) Int. Cl. B65G 15/62; B65G 21/22

(52) U.S. Cl. CPC B65G 15/62; B65G 21/22; B65G 2201/0235; B65G 2207/48

(57) ABSTRACT

An exemplary device may support or guide containers during transport of the containers in a container handling system. The device has at least one main body for supporting or guiding the containers during the transport. The at least one main body can have a surface for making contact with the containers, which surface is textured in order to reduce the contact area between the surface and the containers when transporting the containers. In examples, the at least one main body can be made of a base material and of at least one additive material, which has a surface energy with a polar fraction which differs, preferably substantially, from a polar fraction of a surface energy of the base material and/or of the containers, and preferably made of at least one solid lubricant mate/rial. The device can reduce friction between the containers and the at least one main body.

### TECHNICAL FIELD

The invention relates to a device for supporting or guiding containers during transportation of the containers in a container treatment system. The invention also relates to a container conveyor for transporting containers in a container treatment system. The invention also relates to a method for producing a base body for supporting or guiding containers during transportation of the containers in a container treatment system. The invention additionally relates to a computer program product and a method for transporting containers in a container treatment system.

### TECHNICAL BACKGROUND

Containers can be transported through the individual system parts in container treatment systems and, for example, filled and closed. During transportation, the containers can, for example, be guided along guide railing or supported on belts or mat chains of container conveyors.

When transporting the containers, the guide railing, transport mats etc. can wear out due to friction with the containers. The containers may also develop streaks due to friction. Ultimately, friction during container transportation can lead to impaired line efficiency.

The object of the invention is to provide an improved container transport system in a container treatment system, which is preferably characterized by reduced wear of the containers, guides, etc.

### SUMMARY OF THE INVENTION

The object is achieved by the features of the independent claims. Advantageous developments are specified in the dependent claims and the description.

One aspect of the present disclosure relates to a device for supporting and/or guiding containers during transportation of the containers in a container treatment system. The device has at least one base body for supporting (e.g. from below) and/or guiding (e.g. laterally) the containers during transportation. The base body may have a surface for contacting the containers that is textured to reduce a contact surface between the surface and the containers during transportation of the containers. Alternatively or additionally, the base body may be produced from or comprises a base material and at least one additive material which has a surface energy with a polar fraction (component) which differs, preferably substantially, from a polar fraction (component) of a surface energy of the base material and/or the containers (e.g. plastic containers) (e.g. is greater or smaller), and preferably has at least one solid lubricant material.

Advantageously, the device enables containers and components that come into contact with the containers during container transport to wear out less quickly. Preferably, the device can enable a reduction in friction between the containers and the base body for supporting or guiding the containers during container transport. By means of the textured surface, a true contact surface between the container and the base body can be reduced in order to reduce friction. For example, the textured surface can reduce the friction coefficient of the base body. For example, wear particles can be removed or migrate via grooves in the texture and can therefore no longer rub abrasively over the surface of the container and the surface of the base body. By changing the polar and thus also the disperse fraction of the surface energy of the base body by mixing in at least one additive material, it is also possible to reduce friction between the containers, which are preferably made of plastic, and the base body. The coefficient of friction can depend on the adhesion forces and thus the distribution of polar and disperse bonds in the tribological system. This reduces the adhesive bonds by appropriately selecting the distribution of the polar and disperse portions of the surface energy of the base body relative to the containers by at least one additive material and, if necessary, solid lubricant materials. This means that fewer adhesive bonds are formed between the base body and the container. By increasing or decreasing the polar fraction of the base body, for example, if the surface of the container is predominantly polar, the overlapping surface energy fractions can be reduced, resulting in fewer bonds between the friction partners and reducing friction. Adding at least one solid lubricant material can further reduce friction. A combination of these techniques can be particularly effective in reducing friction.

For example, a polar fraction of a surface energy of the base material can substantially correspond to a polar fraction of a surface energy of the containers, e.g. with a tolerance of, for example, around ±10% or ±5%.

In one exemplary embodiment, the at least one base body and/or the textured surface has a layered structure produced, for example, by means of an additive manufacturing method. Alternatively or additionally, the at least one base body can be extruded or produced by means of injection molding. Alternatively or additionally, the textured surface can be lasered, embossed, rolled, milled, printed (e.g. 3D-printed), injection-molded or extruded. Advantageously, the texturing can be produced in a simple manner.

In another exemplary embodiment, the surface is microtextured and/or nanotextured. Alternatively or additionally, the surface can be textured in such a manner that the contact surface between the surface and the containers is reduced to the micro- and/or nanomillimeter level during transport of the containers. This is particularly effective in reducing friction between the surface and the container.

In a further exemplary embodiment, the textured surface has bionic or geometric shapes, preferably repeating ones. Alternatively or additionally, the textured surface may have honeycombs, scales, roughness peaks, polygons and/or lines. Such shapes have the potential for particularly effective friction and wear reduction.

In a further exemplary embodiment, the at least one base body has a rod-shaped guide railing for a container conveyor, a format part adapted to a format of the containers to be transported, and/or a wear strip of a container guide.

In one embodiment, the at least one base body has a conveyor belt or a conveyor mat, preferably a conveyor mat chain.

In one embodiment, the at least one additive material has a material content of 0.1% to 50% in the at least one base body. Alternatively or additionally, the at least one solid lubricant material has a material content of 0.1% to 30% in the at least one base body. Such proportions are advantageous in that they can be used to optimally coordinate the individual materials to reduce wear and friction.

In one embodiment, the at least one additive material has glass and/or fibers, preferably optical fibers, ceramic fibers, carbon fibers, aramid fibers and/or polyethylene fibers, and/or the polar fraction of the surface energy (or a value characterizing the polar fraction of the surface energy or surface tension) of the at least one additive material is ≥20 mN/m, ≥25 mN/m or ≥30 mN/m. Preferably, glass may have a high polar fraction of the surface energy compared to the base material in order to increase the polar fraction of the surface energy of the base body. Additive materials with a polar surface energy of ≥20 mN/m may be particularly suitable, particularly in combination with plastic containers. Additive materials with a suitable polar fraction of the surface energy of ≥20 mN/m can be taken, for example, from relevant tables in corresponding manuals or textbooks.

In a further embodiment, the at least one solid lubricant material has molybdenum sulfide, tungsten sulfide, hexagonal boron nitride, graphite or diamond-like carbon (DLC). Advantageously, the solid lubricating materials mentioned can be particularly suitable for improving the frictional behavior of the base body with the at least one additive material and the base material.

In a further embodiment, the base material is polyethylene (PE), preferably ultra-high molecular weight polyethylene (PE-UHMW), high molecular weight polyethylene (PE-HMW), high density polyethylene (PE-HD) or low density polyethylene (PE-LD), polypropylene (PP), polyamide (PA), polybutylene terephthalate (PBT), polyetheretherketone (PEEK), polyaryletherketone (PAEK), polyetherketone (PEK), polyoxymethylene (POM) or polytetrafluoroethylene (PTFE).

Another aspect relates to a container conveyor for transporting containers in a container treatment system. The container conveyor has a device according to one of the previous claims. Advantageously, the container conveyor can achieve the same advantages already described for the device.

For example, the container conveyor can have at least one base body for guiding the containers laterally and/or at least one base body for supporting the containers from below.

Preferably, the container treatment system can be designed for the production, cleaning, testing, filling, closing, labeling, printing and/or packaging of containers for liquid media, such as medical vials or hygiene articles, preferably beverages or liquid foodstuffs.

Preferably, the containers can be designed as bottles, cans, canisters, cartons, flacons, etc.

A further aspect relates to a method for the production of a base body for supporting or guiding containers during transportation of the containers in a container treatment system. The method may have texturing of a surface of the base body to reduce a contact surface between the surface and the containers during transportation of the containers (e.g., by means of an additive manufacturing device). Alternatively or additionally, the method may have a mixing of a material composition of the base body comprising a base material and at least one additive material having a surface energy with a polar fraction which differs, preferably substantially, from a polar fraction of a surface energy of the base material and/or the containers (e.g. plastic containers) (e.g. is larger or smaller), and preferably at least one solid lubricant material. Advantageously, the base body produced in this manner can achieve the same advantages already described for the device.

In one exemplary embodiment, the surface is textured by means of an additive manufacturing method, laser cutting, embossing, rolling, milling, injection molding or extrusion.

Preferably, admixing of the at least one additive material and/or the at least one solid lubricant can be performed by an additive manufacturing device. Alternatively, an additive manufacturing device can, for example, be supplied with a material for manufacturing in which the base material is already mixed with the at least one additive material and/or the at least one solid lubricant.

Another aspect relates to a computer program product having (e.g., at least one computer-readable storage medium with instructions stored thereon) that cause an additive manufacturing device (e.g., 3D printer) to perform a method of manufacturing a base body as disclosed herein, or to manufacture a device (or base body) as disclosed herein in a plurality of layers in an additive manufacturing method.

Another aspect relates to a method for transporting containers in a container treatment system. The method has a support (e.g. from below) or a guide (e.g. laterally) of the containers on a surface of at least one base body. The surface can be textured to reduce the contact surface between the surface and the containers, preferably by means of additive manufacturing methods, laser cutting, embossing, rolling, milling, injection molding or extrusion. Alternatively or additionally, the at least one base body is produced from (or has) a base material and at least one additive material which has a surface energy with a polar fraction which differs, preferably substantially, from a polar fraction of a surface energy of the base material and/or the container (e.g. plastic container) (e.g. is larger or smaller), and preferably at least one solid lubricant material. Advantageously, the method can achieve the same advantages already described for the device.

The preferred embodiments and features of the invention described above can be combined with one another as desired.

### BRIEF DESCRIPTION OF THE DRAWINGS

Further details and advantages of the invention are described below with reference to the accompanying drawings, In the figures:

FIG. 1 shows a schematic diagram of a device for transporting containers in accordance with an exemplary embodiment of the present disclosure;

FIG. 2 shows a top view and a perspective view of a schematically depicted base body for guiding or supporting a container;

FIG. 3 shows a top view and a perspective view of a schematically depicted base body for guiding or supporting a container;

FIG. 4 shows a bar chart for the representation of coefficients of friction for different base bodies for guiding or supporting a container;

FIG. 5 shows a purely schematic diagram to explain the influence of a disperse fraction and a polar fraction of a surface energy of two friction partners;

FIG. 6 shows a purely schematic diagram with improved friction behavior between two friction partners compared to FIG. 5.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

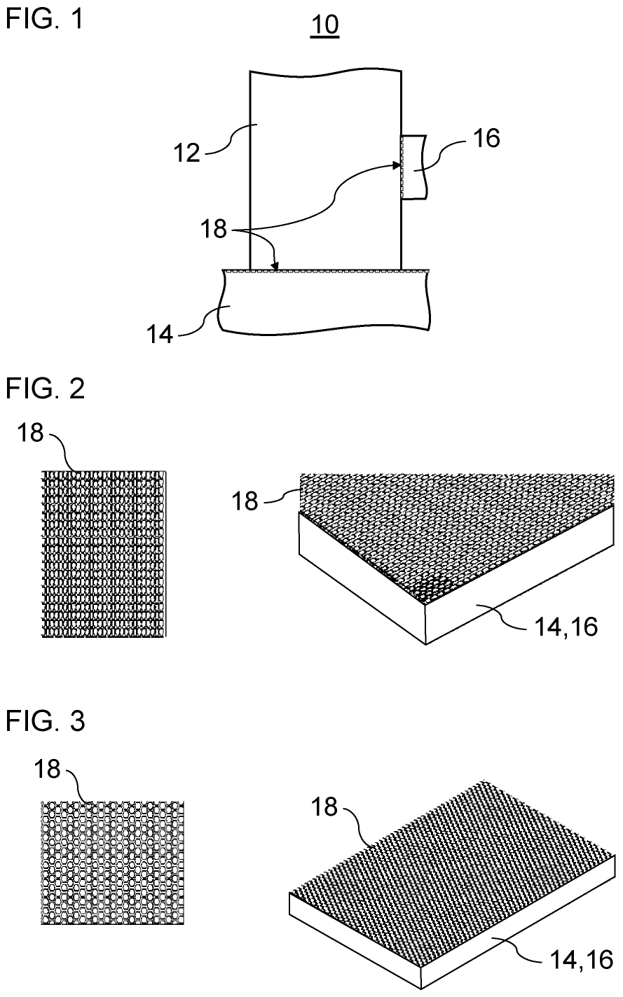

FIG. 1 shows purely schematically a device 10 for guiding and/or supporting containers 12 (only one container 12 is represented) during container transportation. The containers 12 are preferably plastic containers, particularly preferably made of PET, rPET, PP, etc. It is also possible for the containers 12 to be made of glass, aluminum or steel, for example. Preferably, the containers 12 are designed as beverage containers or containers for liquid or paste-like foodstuffs, e.g. as bottles, cans, canisters, cartons or flacons.

Preferably, the device 10 is comprised in a container conveyor of a container treatment system. The container conveyor can transport the containers 12 through the container treatment system. The container conveyor can connect different container treatment devices of the container treatment system or be part of a container treatment device itself. The container conveyor can be designed in any manner to transport containers. For example, the container conveyor can be designed as a transport star or a linear conveyor, e.g. belt conveyor or mat chain conveyor (e.g. with a plastic mat chain).

The device 10 has at least one base body 14, 16.

The base body 14 can support the containers 12 during transportation, preferably from below. A container base of the container 12 can contact the base body 14. For example, the base body 14 can be a conveyor belt or a conveyor mat chain (e.g. plastic mat chain). The base body 14 can move with the containers 12 during transportation or move the containers 12 in the direction of transportation. The base body 14 can be circumferential, for example.

The base body 16 can guide the containers 12 during transportation, preferably laterally. A shell surface of the container 12 can contact the base body 16. The base body 16 can move along with the containers 12 or be arranged stationary or not move along with the containers 12 during transportation. The base body 16 can, for example, be designed as a bar-shaped guide railing. Alternatively, the base body 16 can, for example, be designed as a wear strip of a guide device. Alternatively, the base body 16 can be designed, for example, as a format part or set part that is adapted to a respective format of the containers 12 and is changed, for example, when the format is changed. For example, the format part can have recesses in the shape of cylindrical shell segments for contacting cylindrical shell-shaped portions of the containers 12. For example, the format part can be comprised in a transport star.

It is possible that a further base body (not shown) is provided opposite the base body 16 to guide the containers 12 laterally. The base body 16 and the further base body can guide the containers 12 between them. The further base body can, for example, be designed like the base body 16.

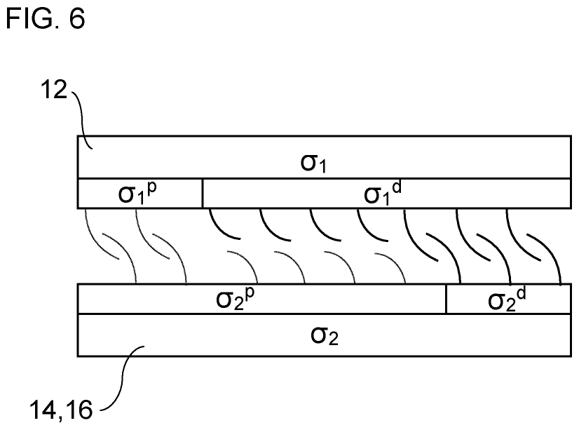

A special feature of the present disclosure is that various measures are proposed for reducing a friction between the container 12 and the base body 14 and/or 16, which can be applied individually or in combination with one another. The measures may be aimed at reducing an adhesive bond between the containers 12 and the base body 14, 16. In tribology, adhesion forces are a particularly important influencing factor. First, with reference to FIGS. 1 to 4, a first measure is explained in which the contact surface between the containers 12 and the base body 14, 16 is considered in order to reduce the adhesion bond. Subsequently, with reference to FIGS. 5 and 6, a second measure is explained which considers the surface energies of the containers 12 and the base body 14, 16 in order to reduce the adhesion bond.

For the sake of simplicity, the following explanations always refer to both base bodies 14, 16. However, it is also possible that only one of the two base bodies 14, 16 is present, or the respective measure for reducing friction is only applied to one of the two base bodies 14, 16, or one of the two base bodies 14, 16 is treated with the first measure and the other of the two base bodies 14, 16 is treated with the second measure.

As mentioned, the first measure for reducing friction is described below with reference to FIGS. 1 to 4. The measure is aimed at reducing the (true) contact surface between the containers 12 and the base body 14, 16 to reduce the tendency to adhere, as less contact surface is provided.

The base body 14, 16 may have a surface 18 that contacts the containers 12. The surface 18 may be textured, namely such that a contact surface between the surface 18 and the container 12 is reduced, for example compared to a surface without texture or compared to a smooth or flat surface. The surface 18 is preferably micro- or nanotextured, i.e. textured in the micrometer or nanometer range.

More specifically, the textured surface 18 may reduce the (true) contact surface between the respective container 12 and the base body 14, 16. The term “(true) contact surface” can refer to the contact surface or contact area size between the container 12 and the base body 14, 16 or the surface 18 at which the container 12 touches the surface 18 on a microscopic level, for example in the micrometer or nanometer range, and where, for example, the interactions and bond formations take place. By minimizing the true contact surface, the surface area at which adhesion formations occur between the container 12 and the base body 14, 16 can be reduced.

The textured surface 18 can be produced in various manners.

For example, the base body 14, 16 can be produced by means of an additive manufacturing method, e.g. from a base material (e.g. a plastic) possibly with additives (e.g. additive material(s) and/or solid lubricant(s)). Additive manufacturing results in a layered structure of the base body 14, 16. The textured surface 18 can preferably be produced or printed directly by means of the additive manufacturing method.

It is possible, for example, for the base body 16 to be extruded, e.g. in the form of a guide or transport railing. It is also possible for the base body 14 to be injection molded, e.g. in the form of conveyor belt segments.

It is also possible for the textured surface 18 to be produced, for example, by means of laser cutting, milling, embossing (e.g. using a die or textured rollers), injection molding (e.g. using cavities in the injection mold) or extrusion.

Preferably, the texture of the surface 18 has a bionic shape or a shape known from geometry. The shape can be repeated continuously in all directions on the surface 18 or be provided in a pattern. The repetition can be regular or irregular. The molds can be oriented in the transport direction of the device 10 or the container 12 or in the opposite direction to the transport direction. However, the molds can also be aligned vertically to the transport direction or at a certain angle to the transport direction.

For example, the textured surface 18 may have honeycomb, scale, roughness peak, polygon and/or line shapes or corresponding patterns. The scale patterns can be, for example, snake scale patterns, sandfish scale patterns or shark scale patterns. The roughness peaks can, for example, be designed and arranged to achieve the lotus effect.

In this context, FIG. 2 shows a particularly preferred exemplary embodiment for the textured surface 18. In accordance with FIG. 2, the surface 18 can be textured with scales or a scale pattern.

In this context, FIG. 3 shows a further particularly preferred exemplary embodiment for the textured surface 18. In accordance with FIG. 3, the surface 18 can be textured with honeycombs or a honeycomb pattern.

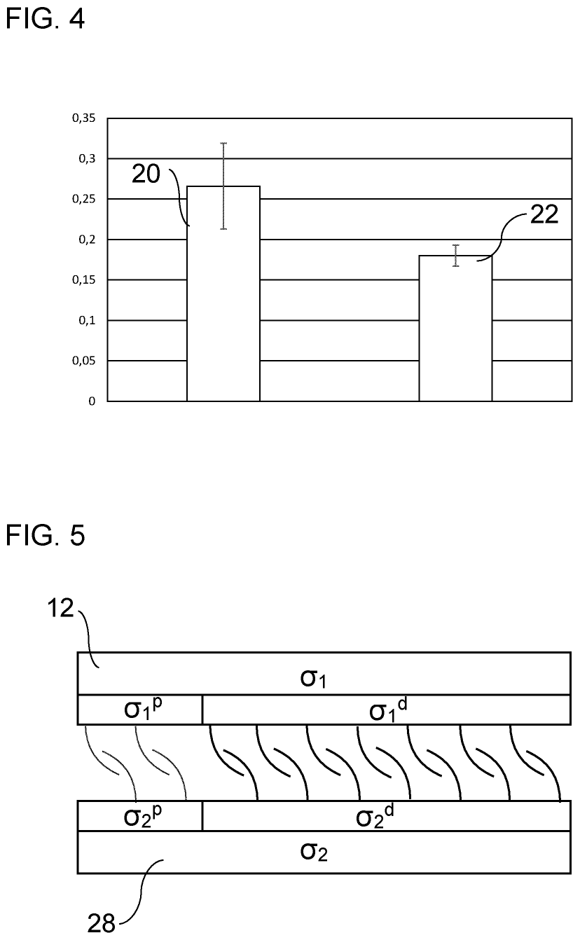

FIG. 4 shows an improvement in the coefficient of friction achieved in experiments. The ordinate (y-axis) represents a value of the coefficient of friction. Two columns 20, 22 for two different test bodies are represented at the abscissa (x-axis). Column 20 shows the coefficient of friction of a test specimen made of PA12 by means of an additive manufacturing method without a textured surface. Column 22 shows the coefficient of friction of a test specimen with a textured surface made from PA12 by means of an additive manufacturing method.

FIG. 4 shows that the coefficient of friction for the test specimen with textured surface (see column 22) is significantly lower than the coefficient of friction for the test specimen without textured surface (see column 20). In detail, the use of a texture on the surface was able to demonstrate a reduction in the coefficient of friction in an area of up to 32% and thus better frictional performance.

With reference to FIGS. 5 and 6, the second measure for reducing friction is described below. The measure aims to allow as little interaction as possible between the disperse and polar fractions of the surface energy of the containers 12 and the base body 14, 16 in order to achieve lower adhesion.

FIG. 5 shows a purely schematic model to illustrate this. The cohesion of atoms and molecules, which determines the surface energy/tension of a substance, is due to different types of interactions. For example, a distinction can be made between disperse and polar interactions. The interactions due to temporal fluctuations in the charge distribution of the atoms or molecules can be described as disperse interactions (e.g. Van der Waals interactions). Polar interactions can be summarized as Coulomb interactions between permanent dipoles and between permanent and induced dipoles (e.g. hydrogen bonds). Accordingly, a surface energy or surface tension σ₁ of the container 12 can also be composed additively of a disperse fraction σ₁^{d} and a polar fraction σ₁^{P}, the sum of which in turn gives the surface tension or surface energy σ₁. The same applies to a conventional base body 28 for guiding or supporting the container 12, which also has a surface energy or surface tension σ₂ with a disperse fraction σ₂^{d} and a polar fraction σ₂^{P}.

A comparison between the (solid) phase of the container 12 and the (solid) phase of the conventional base body 28 with regard to a ratio of disperse to polar fraction of the surface energy/tension enables statements to be made about the adhesion of the two phases to one another. The more the disperse and polar parts match, the more interaction possibilities there are between the phases and the stronger the adhesion and thus friction can be expected. In accordance with conventional technology, FIG. 5 shows purely as a model that the container 12 and the conventional base body 28 can have at least similar disperse and polar surface energy/tension fractions.

In accordance with FIG. 6 and thus the second measure, it is now proposed to increase the polar fraction of the surface energy σ₂^{P} of the base body 14, 16 in order to obtain less correspondence with the disperse and polar fractions of the container 12. The interaction possibilities in the tribological system can be reduced, which means that less adhesion and thus friction can be expected.

To increase the polar fraction of the surface energy σ₂^{P} of the base body 14, 16, at least one appropriately matched additive material can be mixed with a base material during production of the base body 14, 16. The base body 14, 16 can, for example, be produced from a base material and at least one admixed additive material which has a surface energy with a polar fraction which is greater (or smaller) than a polar fraction of a surface energy of the base material and/or the container. In other words, the base body 14, 16 can be produced, for example, from a base material and at least one admixed additive material that has a surface energy with a disperse fraction that is smaller than a disperse fraction of a surface energy of the base material and/or the container.

The base material of the base body 14, 16 is preferably polyethylene (PE), preferably ultra-high molecular weight polyethylene (PE-UHMW), high molecular weight polyethylene (PE-HMW), high density polyethylene (PE-HD) or low density polyethylene (PE-LD), polypropylene (PP), polyamide (PA), polybutylene terephthalate (PBT), polyetheretherketone (PEEK), polyaryletherketone (PAEK), polyetherketone (PEK), polyoxymethylene (POM) or polytetrafluoroethylene (PTFE).

The at least one admixed additive material of the base body 14, 16 may have, for example, glass, which has a high polar surface energy content compared to the base materials mentioned. Preferably, the at least one additive material can have a polar fraction of the surface energy of ≤1 mN/m or ≥20 mN/m, ≥25 mN/m or ≥30 mN/m, preferably depending on a polar fraction of a surface energy of the container. The at least one additive material can have a material content in the base body 14, 16 of, for example, 1% to 50%.

In addition to glass as an additive material, there is a plurality of other materials that can be added to the base material as an alternative or in addition. Other additive materials can be fibers such as optical fibers, ceramic fibers, carbon fibers, but also aramid fibers and polyethylene fibers. Polyethylene (PE), preferably ultra-high molecular weight polyethylene (PE-UHMW), high molecular weight polyethylene (PE-HMW), high density polyethylene (PE-HD) or low density polyethylene (PE-LD), polypropylene (PP), polyamide (PA), polybutylene terephthalate (PBT), polyetheretherketone (PEEK), polyaryletherketone (PAEK), polyetherketone (PEK), polyoxymethylene (POM) or polytetrafluoroethylene (PTFE) can be used as additive material.

Additionally or alternatively, the base body 14, 16 may be produced from at least one admixed solid lubricant material. The at least one optional solid lubricant material may have, for example, molybdenum sulphide (e.g. molybdenum disulphide), tungsten sulphide (e.g. tungsten disulphide), hexagonal boron nitride, graphite or diamond-like carbon (DLC). The at least one solid lubricant material can preferably have a material content in the base body 14, 16 of 0.1% to 30%.

The frictional behavior between a container 12 made of PET and a base body 28 made of PE-UHMW or a base body 14, 16 made of PE-UHMW modified with glass, iron gray and molybdenum disulfide (MoS2) was investigated in experiments. It was shown that a significantly improved coefficient of friction could be achieved with the pairing of container 12 and base body 14, 16. Specifically, the glass was able to increase the polar fraction of the surface energy of the base body 14, 16. This allowed the magnitude of the corresponding disperse and polar fractions of the surface energy to be reduced and thus optimized. The polar proportions of PET of container 12 and the unmodified UHMW-PE of base body 28 are more similar in magnitude than those of PET of container 12 and the modified UHMW-PE of base body 14, 16, which resulted in a higher coefficient of friction and thus greater friction for the first pairing, i.e. container 12 and (conventional) base body 28.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the sub-claims are also disclosed independently of all the features of independent claim 1. All ranges specified herein are to be understood as disclosed in such a way that all values falling within the respective range are individually disclosed, e.g., also as the respective preferred narrower outer limits of the respective range.

### LIST OF REFERENCE SIGNS

10 device
12 containers
14 base element
16 base element
18 surface
20 column
22 column
28 base body

1-15. canceled

16. A device for supporting or guiding containers during transportation of the containers in a container treatment system, having:
at least one base body for supporting or guiding the containers during transportation,
wherein at least one of:
the at least one base body has a surface for contacting the containers which is textured to reduce a contact surface between the surface and the containers during transportation of the containers; and
the at least one base body is produced from a base material and at least one additive material which has a surface energy with a polar fraction which differs from a polar fraction of a surface energy of at least one of the base material and the container.

17. The device according to claim 16, wherein the at least one base body is produced from the base material and the at least one additive material which has the surface energy with the polar fraction which differs from the polar fraction of the surface energy of the at least one of the base material and the container and further of at least one solid lubricant material.

18. The device according to claim 16, wherein at least one of the:
one of the at least one base body and the textured surface has a layered structure;
the at least one base body is extruded or produced via injection molding; and
the textured surface is one of lasered, embossed, rolled, milled, printed, injection-molded and extruded.

19. The device according to claim 16, wherein at least one of:
the surface is one of microtextured and nanotextured; and
the surface is textured in such a manner that the contact surface between the surface and the containers is reduced to one of the micro-and nanomillimeter level during transport of the containers.

20. The device according to claim 16, wherein at least one of:
the textured surface has, at least one of repeating, bionic and geometric shapes; and
the textured surface has at least one of honeycombs, scales, roughness peaks, polygons and lines.

21. The device according to claim 16, wherein the at least one base body has at least one of:
a bar-shaped guide railing for a container conveyor;
a format part which is adapted to a format of the containers to be trans-ported; and
a wear strip of a container guide.

22. The device according to claim 16, wherein:
the at least one base body has one of a conveyor belt and a conveyor mat.

23. The device according to claim 16, wherein at least one of:
the at least one additive material has a material content in the at least one base body of 0.1% to 50%; and
the at least one solid lubricant material has a material content in the at least one base body of 0.1% to 30%.

24. The device according to claim 16, wherein at least one of:
the at least one additive material has at least one of glass and fibers; and
the polar fraction of the surface energy of the at least one additive material is ≥20 mN/m, ≥25 mN/m or ≥30 mN/m.

25. The device according to claim 16, wherein:
the at least one solid lubricant material has molybdenum sulphide, tungsten sulphide, hexagonal boron nitride, graphite or diamond-like carbon (DLC).

26. The device according to claim 16, wherein the base material is polyethylene (PE)

27. The device according to claim 16, wherein at least one of:
the at least one base body has a conveyor mat chain;
the at least one additive material has at least one of glass fibers, ceramic fibers, carbon fibers, aramid fibers and polyethylene fibers; and
the base material includes one of ultra-high molecular weight polyethylene (PE-UHMW), high molecular weight polyethylene (PE-HMW), high density polyethylene (PE-HD), low density polyethylene (PE-LD), polypropylene (PP), polyamide (PA), polybutylene terephthalate (PBT), polyetheretherketone (PEEK), polyaryletherketone (PAEK), polyetherketone (PEK), polyoxymethylene (POM) and polytetrafluoroethylene (PTFE).

28. A container conveyor for transporting containers in a container treatment system, having:
at least one device according to claim 16.

29. A method for producing a base body for supporting or guiding containers during transportation of the containers in a container treatment system, having at least one of:
texturing a surface of the base body to reduce a contact surface between the surface and the containers during transportation of the containers; and
mixing a material composition of the base body comprising a base material and at least one additive material which has a surface energy with a polar fraction which differs from a polar fraction of a surface energy of one of the base material and the containers.

30. The method according to claim 29, wherein the mixing the material composition of the base body includes mixing the material composition of the base body having the a base material and the at least one additive material which has the surface energy with the polar fraction which differs from the polar fraction of the surface energy of the one of the base material and the containers and further of at least one solid lubricant material.

31. The method according to claim 29, wherein:
the texturing of the surface is carried out by means of an additive manufacturing method, lasering, embossing, rolling, milling, injection molding or extrusion.

32. A computer program product having instructions causing an additive manufacturing apparatus to perform a method according to claim 29.

33. A computer program product having instructions causing an additive manufacturing apparatus to produce a device according to claim 16 in a plurality of layers in an additive manufacturing method.

34. A method of transporting containers in a container treatment system, having:
supporting or guiding the containers on a surface of at least one base body, wherein at least one of:
the surface is textured to reduce a contact surface between the surface and the containers via one of additive manufacturing method, lasering, embossing, rolling, milling, injection molding and extrusion; and
the at least one base body is produced from a base material and at least one additive material which has a surface energy with a polar fraction which differs from a polar fraction of a surface energy of one of the base material and the containers.

35. The method according to claim 34, wherein the wherein the at least one base body is produced from the base material and the at least one additive material which has the surface energy with the polar fraction which differs from the polar fraction of the surface energy of the at least one of the base material and the container and further of at least one solid lubricant material.
